(19) United States
(12) Patent Application Publication
(10) Pub. No.: US 2017/0084105 A1
(43) Pub. Date: Mar. 23, 2017

(54) System, Method, and Apparatus for Absentee Ballot Requests

(71) Applicant: Blaise Ingoglia, Spring Hill, FL (US)

(72) Inventor: Blaise Ingoglia, Spring Hill, FL (US)

(21) Appl. No.: 14/857,059

(22) Filed: Sep. 17, 2015

(51) Int. Cl. G07C 13/00; H04L 29/08

(52) U.S. Cl. CPC G07C 13/00; H04L 67/02

(57) ABSTRACT

A system for requesting an absentee ballot includes a portable device (e.g., cellular phone) and a server. The server has data regarding voter registrations and past voting history. An application running on the portable device determines a location, connects to the server, and obtains a set of voters near the location. The application accepts a selection of one of the voters and displays data regarding the voter. The application requests input of at least an email address and a confirmation from the voter. Upon receipt of the email address and the confirmation, an email including a confirmation link is sent to the email address. After receipt of the email by the voter and activating of the confirmation link, an email letter to a supervisor of elections is formatted and sent to the supervisor of elections. The email letter includes a request to provide an absentee ballot for the voter.

### FIELD

This invention relates to the field of elections and more particularly to a system for requesting and verification related to voter registration.

### BACKGROUND

During an election, there are several ways to vote, including appearing in person at a designated polling location and casting your vote in a private voting booth. For those who, for various reasons, desire to vote without appearing in person, absentee balloting was created. The absentee ballot provides a mechanism for voters to place their votes using a form (ballot) and envelope that is mailed to or deposited with the supervisor of elections. The envelope includes a security sleeve to prevent others from knowing how the absent person voted and requires a signature across the seal of the envelope to assure that there was no tampering after the ballot was placed within the envelope. The general purpose of absentee balloting was to assure a higher percentage of voters, especially those who have disabilities, travel often, and/or have work schedules/locations that make it difficult to appear in person at their designated polling location.

Before an election, people are encouraged to vote by many organizations, including non-profit organizations and organizations supporting one or more candidates. Organizations supporting one or more candidates or causes have a vested interest in encouraging voting by individuals that support their candidates and/or their stands.

For example, an organization that believes in limiting gambling in your state wants as many people as possible to vote that feel gambling should be limited when there is a related question on the ballot. In another example, an organization that supports a candidate for congress wants as many people as possible to vote who are likely to vote for that candidate.

It is believed that by removing the need to travel to a polling location, perhaps requiring standing in queue for some time, and using the voting machine sometimes inhibits potential voters from voting. By providing absentee ballots to those individuals, those individuals are more likely to vote.

Organizations supporting one or more candidates and/or causes have people who encourage voters to vote for their candidates and/or causes. Such organizations often employ canvassers or call centers to reach out and try to encourage positive votes for their candidates and/or causes. For example, a canvasser goes door-to-door, providing literature and/or discussion about their candidates and/or causes. In another example, callers in a call center make phone calls to potential voters and provide discussion about their candidates and/or causes. These mechanisms have been used for many years, but once the caller or canvasser finds a person who resonates with their candidate(s) and/or cause, there was no way for the caller or canvasser to improve the chances that the person would actually vote.

What is needed is a system that will automate canvassing and calling and provide improved voter turnout for voters that support candidates and/or causes of the canvasser/caller.

### SUMMARY

In one embodiment, a system for requesting an absentee ballot is disclosed including a portable device such as a cellular phone and a server. The server has data regarding voter registrations and past voting history. An application running on the portable device determines a location, connects to the server, and obtains a set of potential voters near the location. The application running on the portable device accepts a selection of one of the potential voters at the location and displays data regarding the one of the potential voters. The application running on the portable device requests input of at least an email address and a confirmation from the one of the potential voters. Upon receipt of the email address and the confirmation, an email including a confirmation link is sent to the email address. After receipt of the email by the one of the potential voters and activating of the confirmation link, an email letter to a supervisor of elections is formatted and sent to the supervisor of elections. The email letter includes a request to provide an absentee ballot for the one of the potential voters.

In another embodiment, a system for requesting an absentee ballot is disclosed including a call-center computer system and a server. The server has access to data regarding voter registrations and past voting history. An application running on the call-center computer system displays an active call screen regarding a potential voter. The active call screen includes a field for accepting an email address of the potential voter. After accepting of the email address, the application running on the call-center computer system sends an email to the email address, the email including a confirmation link. Upon activation of the confirmation link by the potential voter (e.g., by clicking on the confirmation link), an email letter is formatted and sent to the supervisor of elections. The email letter includes a request to provide an absentee ballot for the potential voter.

In another embodiment, a method of requesting an absentee ballot is disclosed including obtaining data regarding a potential voter from a government system and obtaining additional data from the potential voter. An acknowledgement of permission is obtained from the potential voter. The acknowledgement of permission provides permission for requesting the absentee ballot. An email is sent to the potential voter, the email including a confirmation link. After activation of the confirmation link by the potential voter, a letter to a supervisor of elections is formatted. The letter includes the data regarding the potential voter and the additional data and the letter is then sent to the supervisor of elections.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a data connection diagram of the absentee ballot request system.

FIG. 2 illustrates a schematic view of a typical cell phone 10.

FIG. 3 illustrates a schematic view of a typical computer system such as a server or personal computer.

FIG. 4 illustrates a first cell phone user interface of the absentee ballot request system showing voters in a particular area.

FIG. 5 illustrates a second cell phone user interface of the absentee ballot request system showing details regarding one of the voters.

FIG. 6 illustrates a third cell phone user interface of the absentee ballot request system showing a sample form for requesting an absentee ballot.

FIG. 7 illustrates a fourth cell phone user interface of the absentee ballot request system showing the sample form for requesting an absentee ballot with data entered/obtained.

FIG. 8 illustrates a fifth cell phone user interface of the absentee ballot request system showing the sample form for requesting an absentee ballot with data entered/obtained and confirmation by the voter.

FIG. 9 illustrates a first call center user interface of the absentee ballot request system showing data regarding a new call.

FIG. 10 illustrates a sample verification email of the absentee ballot request system.

FIG. 11 illustrates a sample request letter of the absentee ballot request system.

FIG. 12 illustrates a first exemplary flow chart of the absentee ballot request system.

FIG. 13 illustrates a second exemplary flow chart of the absentee ballot request system.

FIG. 14 illustrates a third exemplary flow chart of the absentee ballot request system.

FIG. 15 illustrates a fourth exemplary flow chart of the absentee ballot request system.

FIG. 16 illustrates a fifth exemplary flow chart of the absentee ballot request system.

FIGS. 17A and 17B illustrate sample data available from the supervisor of elections for political parties.

FIG. 18 illustrates sample data available from the supervisor of elections indicating past voting of voters.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

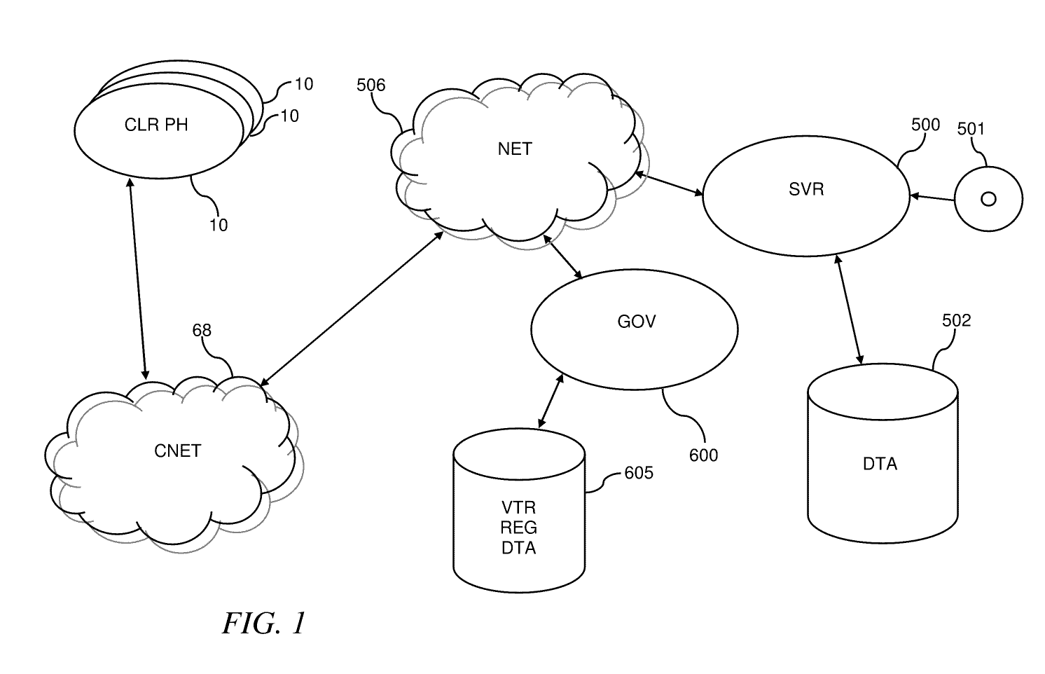

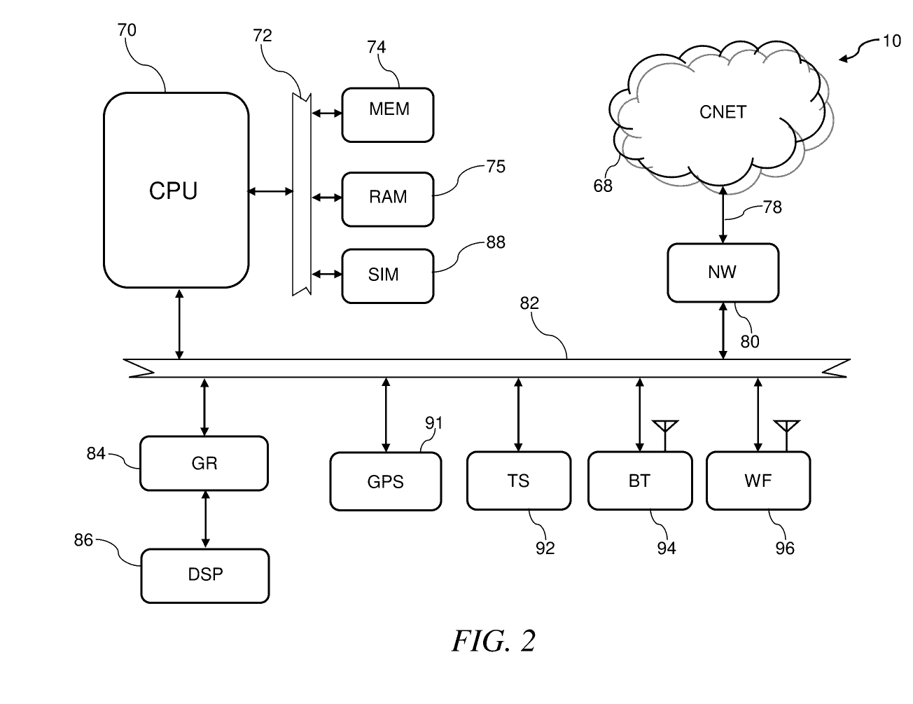

Referring to FIG. 1 illustrates a data connection diagram of the exemplary absentee ballot request system. In this example, one or more cell phones 10 communicate through the cellular network 68 and/or through a wide area network 506 (e.g. the Internet) to a server computer 500. The server computer 500 has access to data storage 502. Although one path between the cell phones 10 and the server 500 is through the cellular network 68 and the wide area network 506 as shown, any known data path is anticipated. For example, the Wi-Fi transceivers 96 (see FIG. 2) of a cell phone 10 is used to communicate directly with the wide area network 506, which includes the Internet, and, consequently, with the server computer 500.

The server computer 500 transacts with the cell phones 10 through the network(s) 68/506 to present menus to/on the cell phones 10, provide data to the cell phones 10, and to complete the process of requesting an absentee ballot. In some embodiments, login credentials (e.g., passwords, pins, secret codes) are stored local to the cell phone 10; while in other embodiments, login credentials are stored in a data storage 502 (preferably in a secured area) requiring a connection to login.

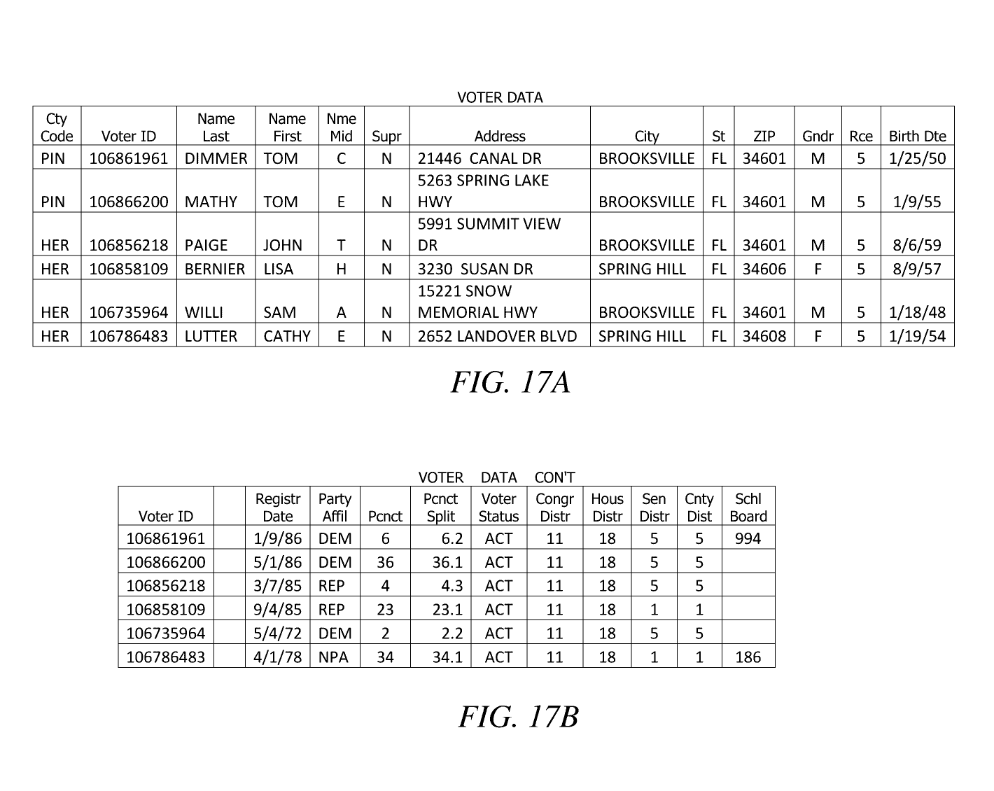

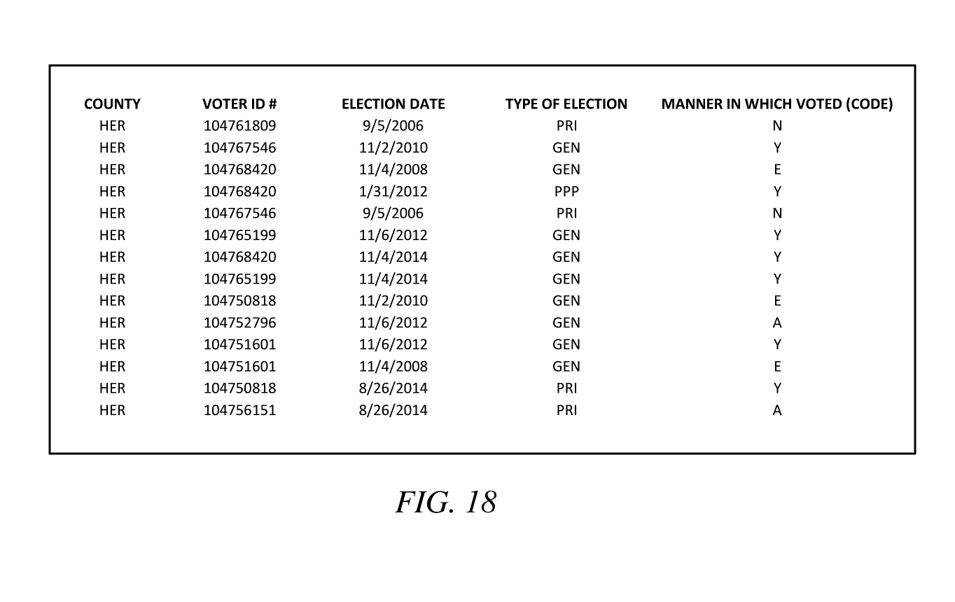

The server computer 500 downloads voting data from a government server 600 (e.g., supervisor of elections, etc.) or from media 501 (e.g. any removable storage such as CD, DVD, Blu-ray, etc.). The data such as that shown in FIGS. 17a, 17b, and 18 is typically stored in a voter registration database 605. The voting data is available to organizations involved with elections and includes voter records as shown in the examples of FIGS. 17A and 17B and voter turnout data as shown in the examples of FIG. 18. The data includes, for example, the voter's name, voter ID, address, party affiliation, recent voting history, districts, etc. Once downloaded, the voter data is stored in the data storage 502 and available for use by call centers and canvassers.

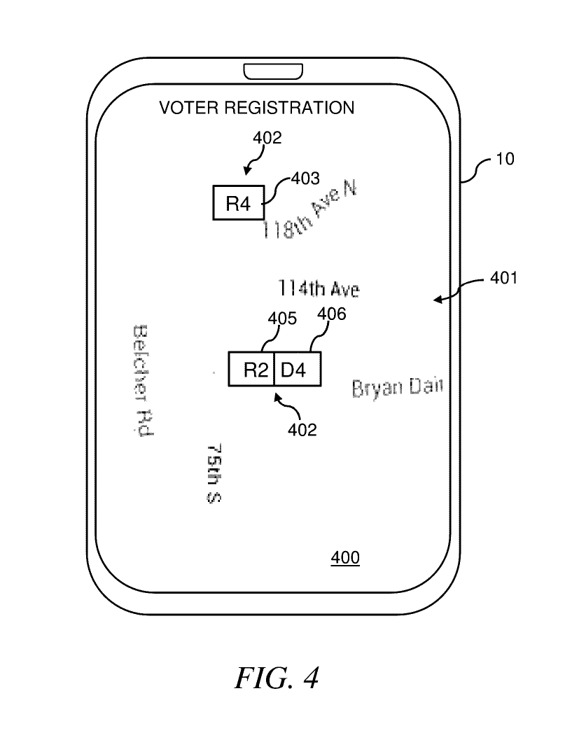

When the application initiates on the cell phone 10, voter data of voters in the geographic area are obtained from the server through a link is established between the cell phone 10 and the server computer 500, typically through the wide-area network 506, though not limited to any particular connection path. The voting data includes one or more records pertaining to voters in the geographic area of the cell phone 10 as determined by an initial GPS reading or by manual entry by a canvasser. Manual entry by a canvasser is made by, for example, entering a street address or using the touch screen 92 (see FIG. 2) of the cell phone 10 to sweep the map (e.g. as shown in FIG. 4) to a new location. Data regarding voters in the selected area is displayed, for example, as shown in FIG. 4.

Referring to FIG. 2, a schematic view of a typical cell phone 10 is shown. The example cell phone 10 represents a typical phone system used for remote or door-to-door canvasing. This exemplary cell phone 10 is shown in its simplest form. Different architectures are known that accomplish similar results in a similar fashion and the present invention is not limited in any way to any particular cell phone 10 system architecture or implementation. In this exemplary cell phone 10, a processor 70 executes or runs programs in a random access memory 75. The programs are generally stored within a persistent memory 74 and loaded into the random access memory 75 when needed. Also accessible by the processor 70 is a SIM (subscriber information module) card 88 having a subscriber identification and often persistent storage. The processor 70 is any processor, typically a processor designed for phones. The persistent memory 74, random access memory 75, and SIM card are connected to the processor by, for example, a memory bus 72. The random access memory 75 is any memory suitable for connection and operation with the selected processor 70, such as SRAM, DRAM, SDRAM, RDRAM, DDR, DDR-2, etc. The persistent memory 74 is any type, configuration, capacity of memory suitable for persistently storing data, for example, flash memory, read only memory, battery-backed memory, magnetic memory, etc. In some exemplary cell phones 10, the persistent memory 74 is removable, in the form of a memory card of appropriate format such as SD (secure digital) cards, micro SD cards, compact flash, etc.

Also connected to the processor 70 is a system bus 82 for connecting to peripheral subsystems such as a cellular network interface 80, a graphics adapter 84 and a touch screen interface 92. The graphics adapter 84 receives commands from the processor 70 and controls what is depicted on a display image on the display 86. The touch screen interface 92 provides navigation and selection features.

In general, some portion of the persistent memory 74 and/or the SIM card 88 is used to store programs, executable code, phone numbers, contacts, and data, etc. In some embodiments, other data is stored in the persistent memory 74 such as audio files, video files, text messages, etc.

The peripherals are examples and other devices are known in the industry such as Global Positioning Subsystem 91, speakers, microphones, USB interfaces, Bluetooth transceivers 94, Wi-Fi transceivers 96, image sensors, temperature sensors, etc., the details of which are not shown for brevity and clarity reasons.

The cellular network interface 80 connects the cell phone 10 to the cellular network 68 through any cellular band and cellular protocol such as GSM, TDMA, LTE, etc., through a wireless medium 78. There is no limitation on the type of cellular connection used. The cellular network interface 80 provides voice call, data, and messaging services to the cell phone 10 through the cellular network.

For local communications, many cell phones 10 include a Bluetooth transceiver 94, a Wi-Fi transceiver 96, or both. Such features of cell phones 10 provide data communications between the cell phones 10 and data access points and/or other computers such as a personal computer (not shown).

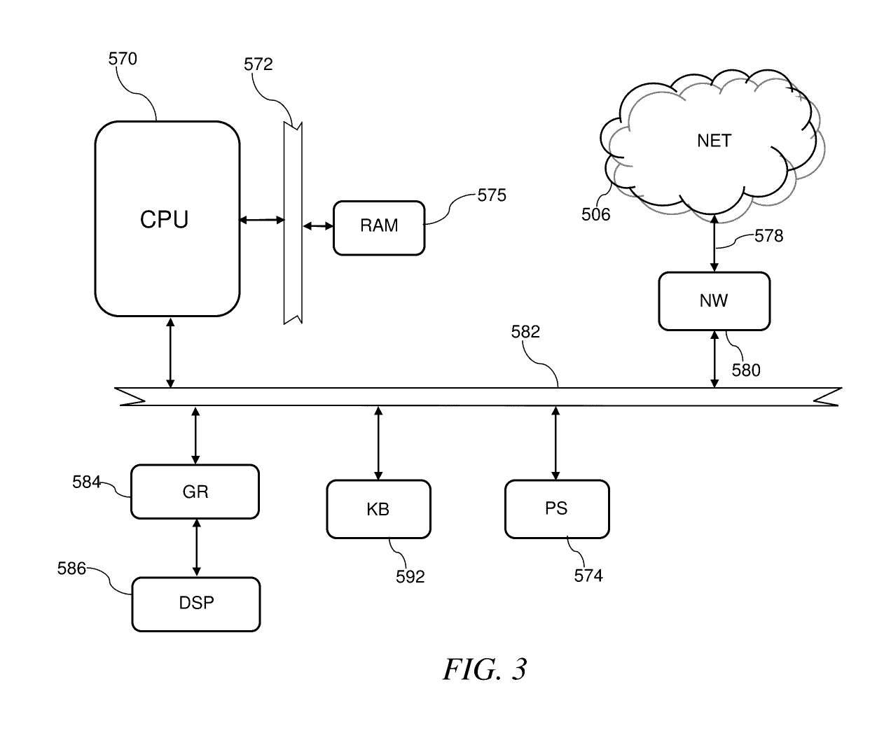

Referring to FIG. 3, a schematic view of a typical computer system (e.g., server 500) is shown. The example computer system 500 represents a typical computer system used for back-end processing, etc. This exemplary computer system is shown in its simplest form. Different architectures are known that accomplish similar results in a similar fashion and the present invention is not limited in any way to any particular computer system architecture or implementation. In this exemplary computer system, a processor 570 executes or runs programs in a random access memory 575. The programs are generally stored within a persistent memory 574 and loaded into the random access memory 575 when needed. The processor 570 is any processor, typically a processor designed for computer systems with any number of core processing elements, etc. The random access memory 575 is connected to the processor by, for example, a memory bus 572. The random access memory 575 is any memory suitable for connection and operation with the selected processor 570, such as SRAM, DRAM, SDRAM, RDRAM, DDR, DDR-2, etc. The persistent memory 574 is any type, configuration, capacity of memory suitable for persistently storing data, for example, magnetic storage, flash memory, read only memory, battery-backed memory, magnetic memory, etc. The persistent memory 574 is typically interfaced to the processor 570 through a system bus 582, or any other interface as known in the industry.

Also shown connected to the processor 570 through the system bus 582 is a network interface 580 (e.g., for connecting to a data network 506), a graphics adapter 584 and a keyboard interface 592 (e.g., Universal Serial Bus—USB). The graphics adapter 584 receives commands from the processor 570 and controls what is depicted on a display image on the display 586. The keyboard interface 592 provides navigation, data entry, and selection features.

In general, some portion of the persistent memory 574 is used to store programs, executable code, voter data, contacts, and other data, etc.

The peripherals are examples and other devices are known in the industry such as speakers, microphones, USB interfaces, Bluetooth transceivers, Wi-Fi transceivers, image sensors, temperature sensors, etc., the details of which are not shown for brevity and clarity reasons.

Referring to FIGS. 4-8, exemplary canvasser user interfaces of the absentee ballot request system are shown. Although many user interfaces are anticipated, an example user interface is used to show a canvasser application, typically running on a cellular phone 10 or other portable device. When the canvasser application starts, a user interface 400 is displayed showing voters that are in a particular location. The particular location is established, for example, by reading the current location from the GPS 91 of the cellular phone 10 or by manually entering, for example, an address. Once an initial location is determined, a map 401 is displayed showing, for example, streets in the location. As known, the user interfaces is anticipated to allow zooming in/out and panning to change the location.

In the example user interface 400, three potential voters have been found, a first potential voter in a first residence 402, noted as an icon 403 R4 (e.g., republican, voted four out of the last five elections) in a first icon. Two other potential voters in a second residence 404 noted as R2 in a second icon 405 and D4 in a third icon 406 (e.g., republican, voted two out of the last five elections and democrat voted four out of last five elections). An example of one method used to determine the prior history using voting records is described with FIG. 18.

In such, the application running on the cell phone 10 has communicated with the server 500 and the server, using data in the data storage 502 that was previously obtained, for example, as obtained from the supervisor of elections (see FIGS. 17A, 17B, and 18), has returned data for the three potential voters.

Armed with this data, the canvasser is able to decide which potential voters are likely to vote for the canvasser's candidates and/or causes. For example, if the canvasser represents a democratic candidate, it is likely futile to visit the first residence 402 having a single potential voter who voted republican four out of the last five elections. If the canvasser is promoting a republican candidates and/or causes, the canvasser's time is best spent making sure the potential voter at the second residence 404 that voted republican in two of the last five elections is going to vote in the upcoming election and understands the candidates and issues.

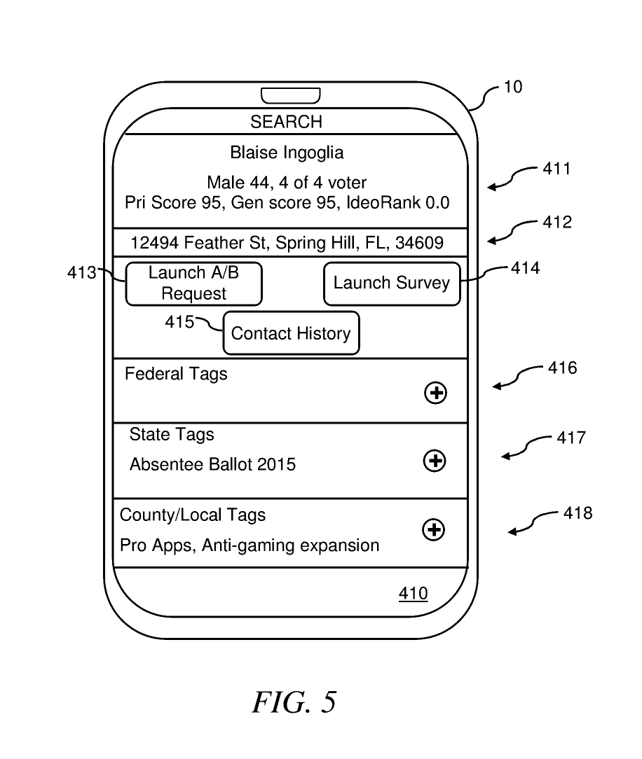

By selecting the icon 403/405/406 of one of the potential voters (e.g., by tapping on the icon 403 showing R4 in the first residence 402), details of the potential voter are retrieved and displayed as shown in FIG. 5. In this voter detail user interface 410, the name of the potential voter and various scores are displayed in a first area 411 and the address of the residence is displayed in a second are 412. If any tags are available, lists of the tags 416/417/418 are displayed. Tags are, for example, any known information about the potential voter such as whether they are for or against certain issues, whether they have voted by absentee ballot, etc. Each lit of tags 416/417/418 has an expansion capability to provide further details for the tags.

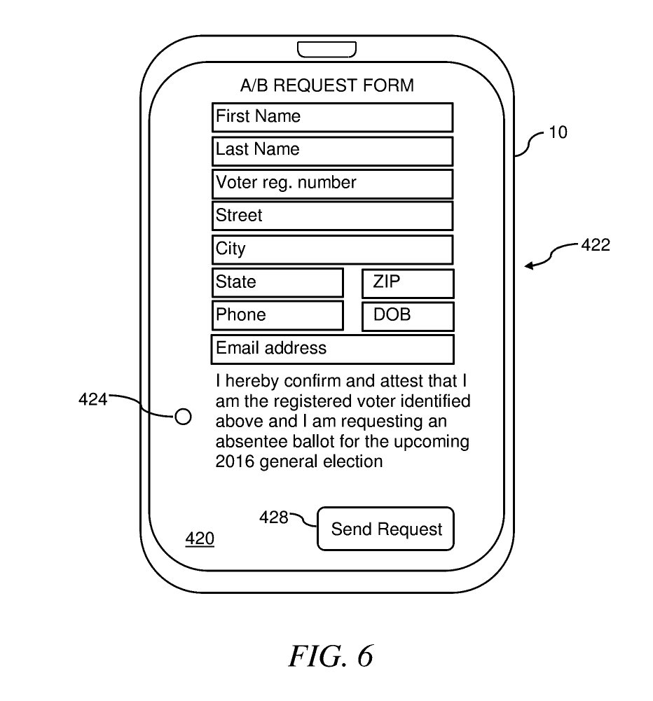

From the voter detail user interface 410, the canvasser is able to launch an absentee ballot request 413, launch a survey 414, or request history 415 related to prior contacts with the potential voter. The absentee ballot request 413 invokes the absentee ballot request user interface 420 as shown in FIGS. 6-8. The launch survey request 414 invokes a user interface to present survey questions to the potential voter. The request history 415 function accesses additional information about prior contacts with the potential voter and displays the information in a history user interface.

The absentee ballot request user interface 420 as shown in FIGS. 6-8 provides the canvasser with a tool to initiate a request for an absentee ballot on behalf of the potential voter. Any request for an absentee ballot must be made by the voter. Therefore, a surrogate cannot make the request, but the voter can approve such a request as long as there is sufficient assurance that the voter is making the request. In FIG. 6, an absentee ballot request form 420 is shown before data is populated. The data area 422 of the absentee ballot request form 420 includes all information required by the supervisor of elections to order an absentee ballot such as name of the voter, voter registration number, address, phone number, etc. Although a specific set of data is shown in the data area 422, it is fully anticipate that in other embodiments; more or less data is available and/or requested from the server 500.

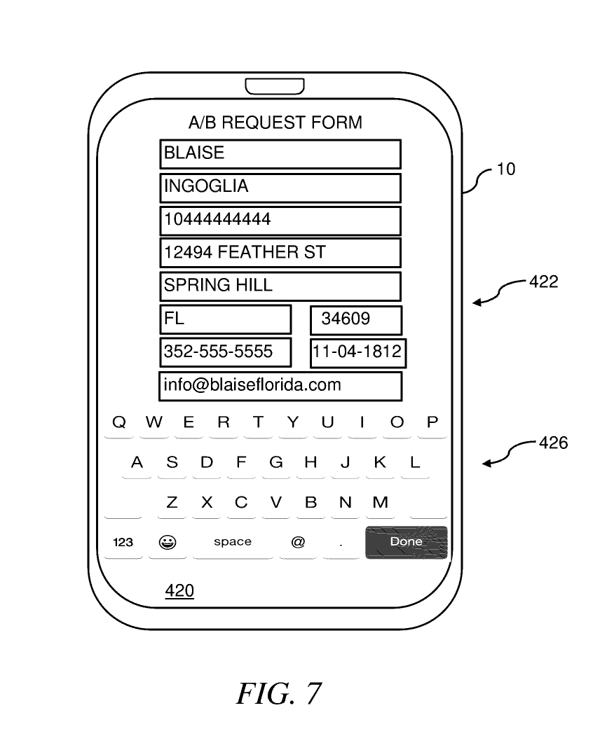

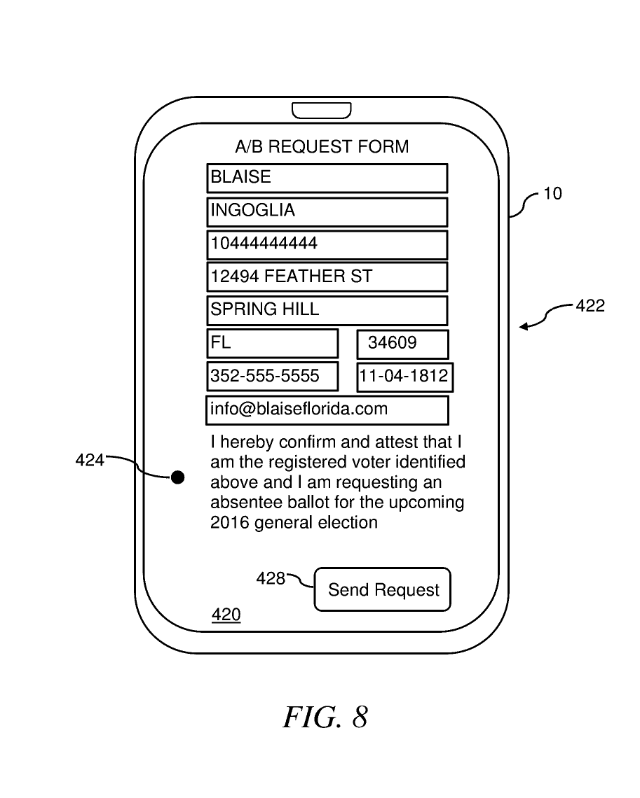

The server 500 has information regarding the voters that was previously downloaded from, for example, the supervisor of elections and stored in the data storage 502. This data includes, for example, each voter's name, address, voter registration number, date-of-birth, etc. This data is downloaded from the server 500 and the data area is populated with available data as shown in FIG. 7. Except for the voter's phone number (e.g., cell phone number) and email address. The voter enters their phone number and email address into the appropriate data fields in the data area 422 using an on-screen keyboard 426 as shown in this example, or in any other way as known in the industry (e.g., a hardware keyboard, speech recognition, etc.). In FIG. 7, the phone number and email address have been entered using the on-screen keyboard 426. Once finished, the voter invokes the “Done” feature and the on-screen keyboard 426 disappears as shown in FIG. 8. Now, the voter acknowledges confirmation that they are requesting an absentee ballot and, in some embodiments, that they are giving permission to be contacted directly at the email address and/or phone number that has been provided. The confirmation is by selecting a check box 424 that accompanies a block of text indicating that they are making the request. Once the voter reads and agrees (e.g., by clicking or tapping on the check box 424, the send request function 428 is invoked to initiate the process of requesting an absentee ballot for this voter.

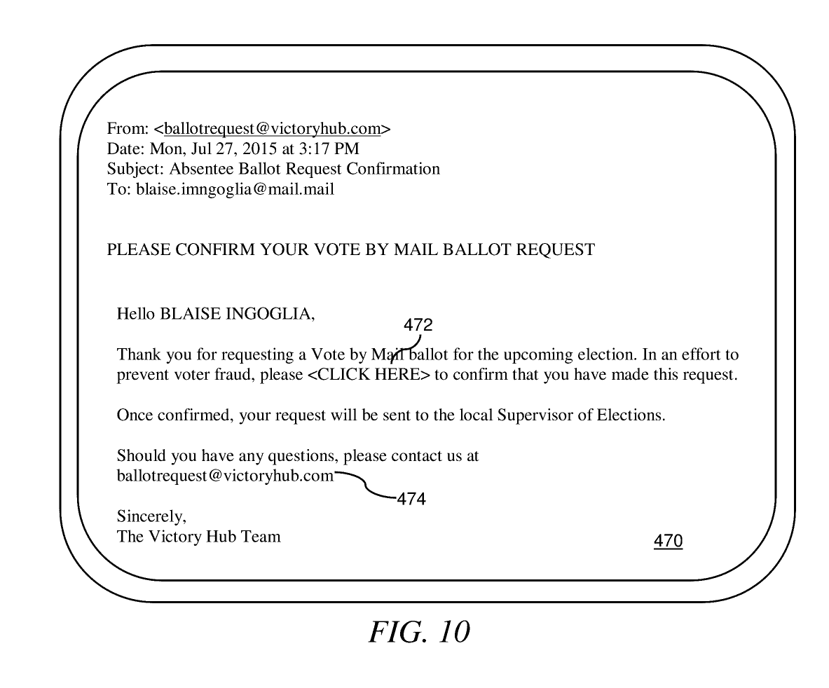

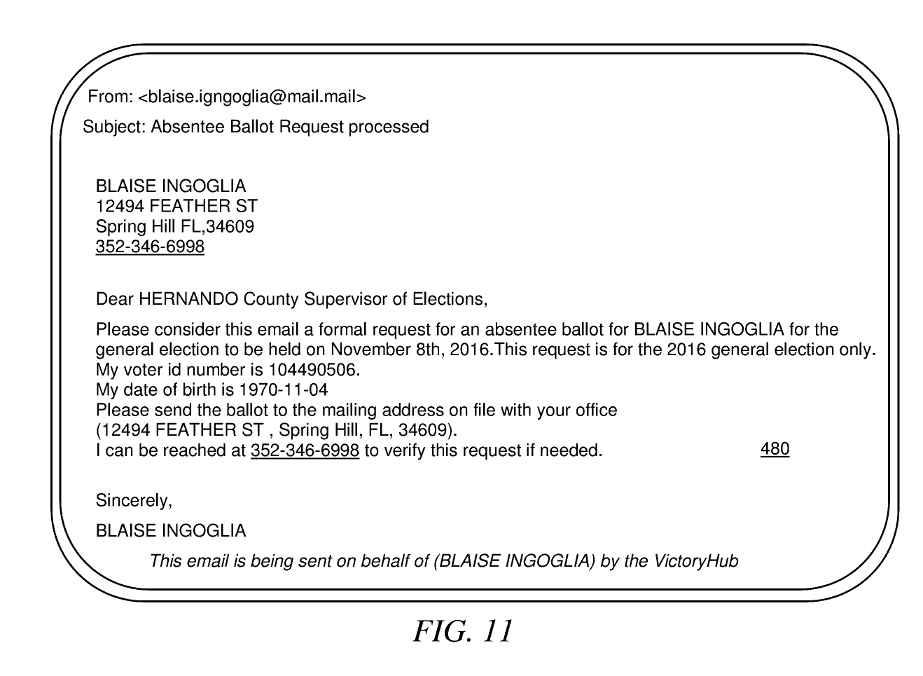

The process for generating/sending the confirmation email to the voter and generating/sending the absentee ballot request to the supervisor of elections follows the same or similar steps as the process for requesting the absentee ballot is described in FIGS. 10 and 11.

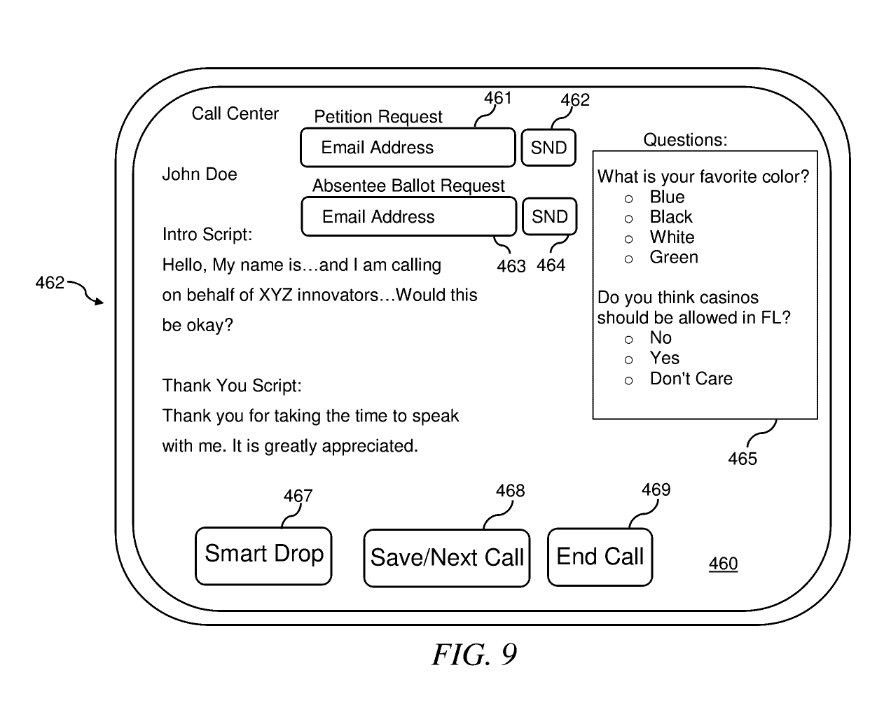

Referring to FIG. 9, a call center user interface 460 of the absentee ballot request system is shown. Call centers are well known in the industry. Typically, call center operators are presented a call center user interface 460 while an active call to the potential voter is connecting or has connected. In this call center user interface 460, an introduction script 462 is provided for the call center operator to read once the person answers. Depending upon the reason for calling, the call center operator will perform any of several operations.

If the called person does not want to participate, the call center operator invokes the smart-drop function 467 or the end-call function 469 and waits for the next call.

For some calling reasons, the call center operator polls the called person using, for example, polling questions 465. Once done, the call center operator thanks the called person and invokes the save/next call function 468.

For attempting to get the called person to vote, the call center operator has a feature to request an absentee ballot. To do so, the call center operator asks the called person for at least an email address and enters the email address into the Absentee Ballot Request field 463. Once complete, the call center operator invokes the AB-send function 464 and the process for requesting the absentee ballot as described in FIGS. 10 and 11 completes the absentee ballot request.

In some embodiments, the call center operator is calling to determine if the called person is willing to sign a petition. The call center operator explains the petition and/or reads the petition to the called person and, if the called person agrees to sign the petition, the call center operator asks the called person for at least an email address and enters the email address into the Petition Request field 461. Once complete, the call center operator invokes the PET-send function 462 and either the called person's name is included as a signature on the petition, or, if required, an email is processed to assure the called person has a valid email address and agrees to sign the petition. This is, for example, mailing an acknowledgement to the email address that includes a copy of the petition and a link that the called person selects to approve being added to the petition as a signer. Once done, the call center operator thanks the called person and invokes the save/next call function 468.

Referring to FIGS. 10 and 11, sample user interfaces 470/480 for completion of the absentee ballot are shown. In FIG. 10, a sample verification email 470 of the absentee ballot request system is shown. For various reasons, including verification of the voter, tracking that the voter made the request for an absentee ballot, logging, etc., a verification email 470 or similar is sent by email to the voter. The email includes, for example, the voter's name and reason for the email, a link 474 should the voter need to contact someone with questions, and a confirmation link 472. To finish the process or requesting an absentee ballot, the voter invokes the confirmation link 472. Once the voter invokes the confirmation link 472, a request letter 480 as for example, the sample request letter 480 shown in FIG. 11 is sent to the associated supervisor of elections as an email from the voter. The letter includes the voter's name, address, voter-id, date-of-birth, and contact information such that the supervisor of elections is able to verify this information. As required, a note is placed at the bottom of the request letter 480 indicating that the letter didn't come from the voter, but was sent on behalf of the voter.

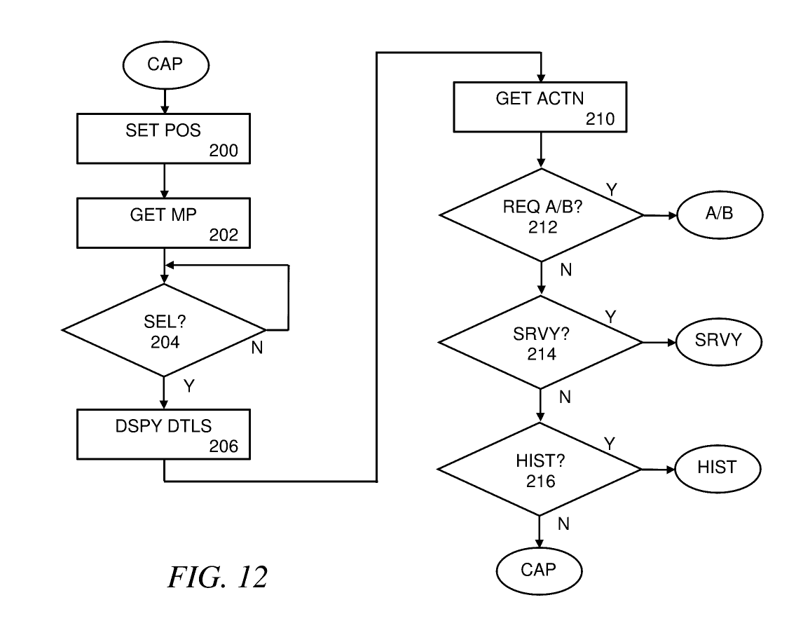

Referring to FIG. 12-16, exemplary flow charts of the absentee ballot request system are shown. In FIG, 12, an exemplary flow of the cell phone application is described. In this example, the cell phone application obtains a position 200 such as a street address, latitude/longitude, etc., either by reading the GPS 91 hardware of the cell phone 10 or through data entry, or a combination of such. Any form of entering the location and maneuvering the location (e.g., zoom in/out, panning, etc.) is included here within.

Next, the cell phone application downloads 202 a map 401 corresponding to the position/location. The map 401 is downloaded 202 as known in the industry, for example, from a general purpose mapping system or from the server 500. The map 401, for example, includes streets in the locale of the canvasser and is overlaid with potential voter icons 403/405/406 for each residence 402/404. Once the map 401 and voter icons is displayed and set to the desired location, the cell phone application waits for a selection 204 to be made, for example, by taping on one of the voter icons. After the selection 204, details of the associated voter are displayed 206, for example, as in FIG. 5. The data in the details are either downloaded from the server 500 when the voter icon is selected or in advance of when the voter icon is selected to increase robustness of the cell phone application.

Now the cell phone application gets an action to perform 201 and selects an appropriate routine to process the action, such as requesting an absentee ballot 212, requesting a survey 214, obtaining history 216, etc.

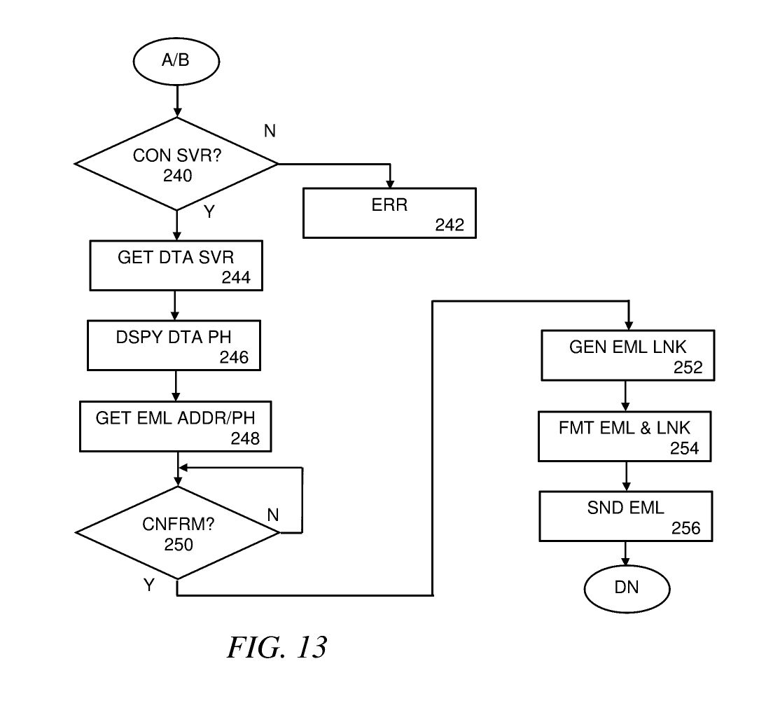

If the cell phone application gets an action to perform 201 requesting an absentee ballot 212, the absentee ballot as in FIG. 13 runs. The cell phone application attempts to connect 240 to the server 500. If the cell phone application cannot connect 240, an error is announced 242. Once the cell phone application connects 240 to the server 500, the cell phone application gets any needed voter information 244 from the server (unless the data has already been downloaded) and displays the data 246, for example in an absentee ballot request form 420 as shown in FIGS. 6-8. The cell phone application then obtains 248 an email address and/or a phone number from the voter, for example, through data entry on an on-screen keyboard, from a physical keyboard, from speech recognition, etc.

Once the email address and/or phone number is obtained, the voter must select the confirmation icon 424 as shown in FIGS. 6-8. The cell phone application waits for the confirmation 250 and once the confirmation is received, a confirmation email link is generated 252 either by the cell phone application or by the server 500. The confirmation email link is a unique link that is included in the email to the voter such that the vote, selecting the confirmation email link, acknowledges that they have requested an absentee ballot. An email to the voter is formatted 254, including the generated confirmation email link and the formatted email with the generated confirmation email link is sent 256 to the voter at the email address provided in the steps above. Note that the generation of the confirmation email link 252, formatting of the email 254, and/or the sending of the email 256 are performed by either the cell phone application, software running on the server 500, or a combination of both.

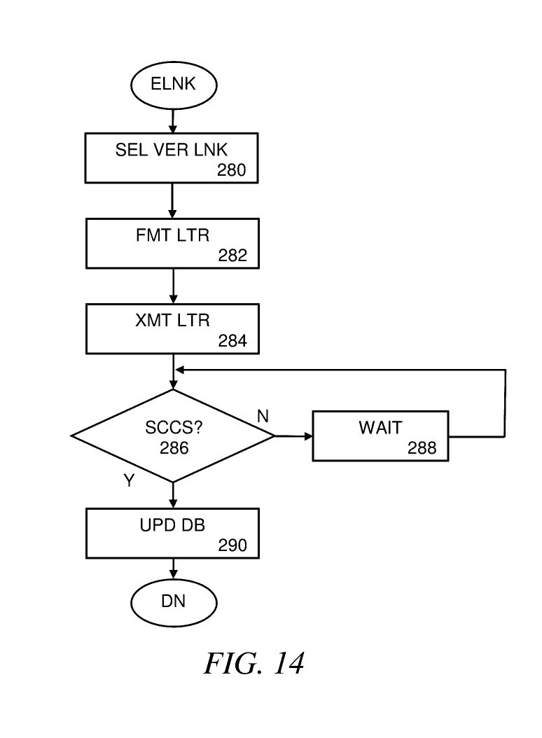

In FIG. 14, it is shown what happens when the voter receives the email, for example, on their own cell phone 10, on a personal computer, tablet computer, etc. The voter receives the verification email for example the verification email 470 shown in FIG. 10. After reading the email, the voter selects 280 the confirmation email link. Upon selecting 282 the confirmation email link, software running on the server 500 receives indication of such and formats the absentee ballot request letter, for example the absentee ballot request letter 480 of FIG. 11. The letter is populated with data obtained from the supervisor of elections as well as the email address and/or phone number of the voter. The formatted letter is then transmitted 284 to the computer system of the associated supervisor of elections. In some embodiments, if transmission is not successful 286, a delay is taken 288 and the transmission success 286 is checked again. In such, it is anticipated that recovery steps and/or manual intervention is taken if, after a period of time, the formatted letter has not been successfully transmitted. Once the formatted letter has been successfully transmitted 286, the data 502 is updated to reflect that the absentee ballot was requested.

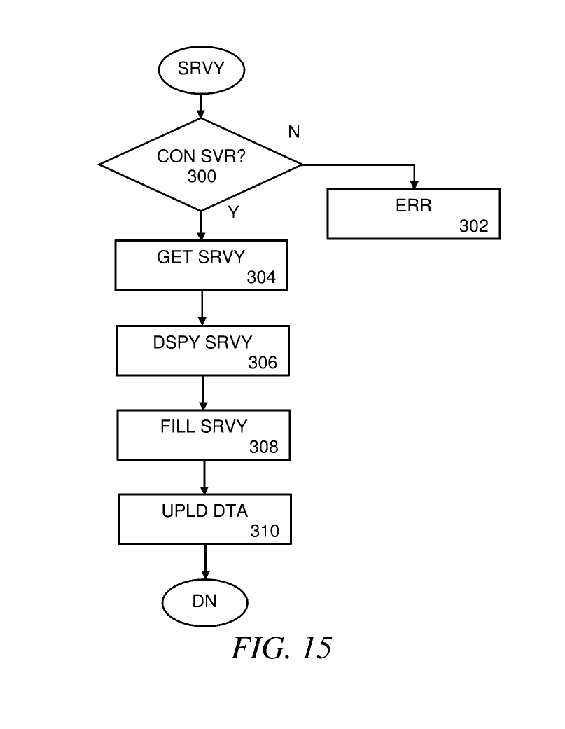

In FIG. 15, it is shown what happens when the cell phone application requests a survey. The cell phone application attempts to connect 300 to the server 500. If the cell phone application cannot connect 300, an error is announced 302. Once the cell phone application connects 300 to the server 500, the cell phone application gets the content of the survey 304 (e.g., questions and possible answers) and displays the content of the survey 306 for the canvasser to see. The canvasser, using the survey, polls the voter and as the voter answers, the canvasser fills in the survey 308 using input directives (e.g., tapping, voice recognition, etc.) of their cell phone 10. After the survey is completed, the responses are uploaded 310 to the server 500 and the responses are processed and stored in the storage 502.

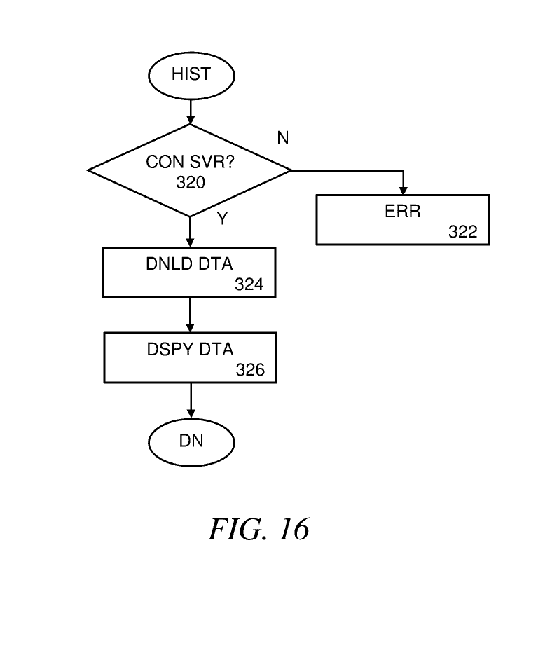

In FIG. 16, it is shown what happens when the cell phone application requests additional data. The cell phone application attempts to connect 320 to the server 500. If the cell phone application cannot connect 320, an error is announced 322. Once the cell phone application connects 220 to the server 500, the server downloads 324 any available additional data as requested by the cell phone application and then displays 326 the data.

Referring to FIGS. 17A and 17B, sample data available from the supervisor of elections for political parties is shown. In this example, one possible set of data is shown as available from one specific supervisor of elections and it is fully anticipated that in other jurisdictions, more data, less data, different data, or data that is ordered differently is available. Note the FIG. 17B is a continuation of the rows of FIG. 17A.

In general, much of the data shown in FIGS. 17A and 17B is not readily available for the public, but is often made available to certified election committees. When the data is made available to a certified election committee, the server 500 connects to the government server 600 to access the allowable voter registration data 605. The data (e.g., data similar to that in FIGS. 17A and 17B) is copied and transferred from the government server 600 to the server 500 in any way known, for example, using a file transfer protocol through the network 506. Any form of transfer, network and/or connection is anticipated.

The data from the government server 600 is processed and stored in the storage 502 for later access by, for example, the cell phone application.

Referring to FIG. 18, sample data available from the supervisor of elections indicating past voting of voters is shown. Such data is made available by, for example, the state governments, to political election committees. The data is provided to legitimate political organizations and registered candidates through any transfer mechanism known, including file transfer and delivery on media such as a disk (e.g. CD-ROM, etc.).

The data shown in FIG. 18 is used to determine the number of times an individual voter has voted in the past sequence of elections. In the examples above, the past sequence of elections is the past five elections, though there is no limitation on the number of elections or the selected sequence of elections. For example, in another scenario, the number of times an individual has voted in major elections in the past 7 major elections is determined, etc. The data shown in FIG. 18 is substantially abbreviated (many more rows), as there are typically millions of rows in a typical file.

One way to determine the number of times the individual voter has voted in the past sequence of elections is to sort the data by voter-id#, then by election date. This will create a list having voter-id numbers clustered in successive rows such with ordered voting dates. For example if the voter having a voter id# of 104767546 voted on Nov. 3, 2011 and Nov. 2, 2010, then these two rows would be next to each other. Then, by processing the list, line-by-line, looking for a change in voter-id#, the first row would have a voter id# of 104767546, the second row would have a voter id# of 104767546, and the next row would have a different voter id#, indicating that this voter voted twice in the past n elections. If that voter is registered as republican, that voter would be assigned an R2 value (republican, voted in 2 of the past n elections). If that voter is registered democratic, that voter is assigned a D2 value (democratic, voted in 2 of the past n elections), etc.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system for requesting an absentee ballot, the system comprising:
a portable device;
a server, the server having data regarding voter registrations and past voting history;
an application running on the portable device determines a location and the application running on the portable device connects to the server and obtains from the server a set of potential voters near the location;
the application running on the portable device accepts a selection of one of the potential voters at the location and the application running on the portable device displays data regarding the one of the potential voters; the application running on the portable device requests input of at least an email address of the one of the potential voters and a confirmation;
upon receipt of the email address of the one of the potential voters and the confirmation, the application running on the portable device sends an email to the email address of the one of the potential voters, the email address including a confirmation link; and
upon receipt of the email by the one of the potential voters followed by activating of the confirmation link by the one of the potential voters, an email letter to a supervisor of elections is formatted and sent to the supervisor of elections, the email letter including a request to provide an absentee ballot for the one of the potential voters.

2. The system of claim 1, whereas the application running on the portable device further requests a phone number of the one of the potential voters.

3. The system of claim 2, wherein the email letter includes a name, an address, a voter-id, and the phone number of the one of the potential voters.

4. The system of claim 1, whereas the application running on the portable device determines the location by reading the location from a Global Positioning Subsystem of the portable device.

5. The system of claim 1, whereas the application running on the portable device determines the location from a value that is inputted into the portable device.

6. The system of claim 1, wherein the input of the confirmation is performed by activation of a selection box on the portable device.

7. The system of claim 1, wherein the confirmation link is a web-link within the email and whereas activating of the confirmation link is performed by clicking on the web-link.

8. The system of claim 7, whereas after clicking on the web-link, the server formats and sends the letter to the supervisor of elections.

9. The system of claim 1, wherein the portable device is a cellular phone.

10. A system for requesting an absentee ballot, the system comprising:
a call-center computer system;
a server, the server having data regarding voter registrations and past voting history;
an application running on the call-center computer system displays an active call screen regarding a potential voter, the active call screen including a field for accepting an email address of the potential voter;
after accepting of the email address, the application running on the call-center computer system sends an email to the email address, the email including a confirmation link; and
upon activation of the confirmation link by the potential voter, an email letter is formatted and sent to the supervisor of elections, the email letter including a request to provide an absentee ballot for the potential voter.

11. The system of claim 10, whereas the application running on the call-center computer system further requests a phone number of the potential voter.

12. The system of claim 11, wherein the email letter includes a name, an address, a voter-id, and the phone number of the potential voter.

13. The system of claim 10, wherein the confirmation link is a web-link within the email and whereas activating of the confirmation link is performed by clicking on the web-link.

14. The system of claim 13, whereas after clicking on the web-link, the server formats and sends the letter to the supervisor of elections.

15. A method of requesting an absentee ballot, the method comprising:
obtaining data regarding a potential voter from a government system;
obtaining additional data from the potential voter;
obtaining an acknowledgement of permission from the potential voter, the acknowledgement of permission providing permission for requesting the absentee ballot;
sending an email to the potential voter, the email including a confirmation link;
after activating the confirmation link by the potential voter, formatting a letter to a supervisor of elections including the data regarding the potential voter and the additional data; and
sending the letter to the supervisor of elections.

16. The method of claim 15, wherein the additional data includes a phone number and an email address of the potential voters.

17. The method of claim 15, wherein the data regarding the potential voter includes a name, an address, and a voter-id of the potential voters.

18. The method of claim 15, whereas the step of obtaining an acknowledgement of permission from the potential voter is performed by activating a selection box on a user interface.

19. The method of claim 15, wherein the confirmation link is a web-link within the email and whereas the step of activating of the confirmation link by the potential voter is performed by clicking on the web-link.

20. The method of claim 19, whereas after clicking on the web-link, the steps of formatting the letter and sending the letter are performed by a server.
